(19) United States
(12) Patent Application Publication
(10) Pub. No.: US 2014/0180787 A1
(43) Pub. Date: Jun. 26, 2014

(54) INTENT TO SPEND ANALYTICS PLATFORM

(71) Applicant: CORTEX MCP, INC., Ladera Ranch, CA (US)

(72) Inventor: Shaunt M. Sarkissian, Ladera Ranch, CA (US)

(73) Assignee: CORTEX MCP, INC., Ladera Ranch, CA (US)

(21) Appl. No.: 13/834,763

(22) Filed: Mar. 15, 2013

Related U.S. Application Data
(60) Provisional application No. 61/740,731, filed on Dec. 21, 2012.

(51) Int. Cl. G06Q 30/02

(52) U.S. Cl. CPC G06Q 30/0251
USPC 705/14.41; 705/14.49

(57) ABSTRACT

In various embodiments, a computer-implemented method for providing an intent to spend analytics platform is disclosed. The computer-implemented method comprises receiving, by a processor configured to execute a pre-commerce screening engine, one or more parameters of a payment instrument. The computer-implemented method further comprises generating, by the processor, one or more targeted offers based on the one or more parameters of the payment instrument.

### CROSS-REFERENCE TO RELATED APPLICATION

This application claims the benefit, under 35 U.S.C. §119(e), of U.S. provisional patent application No. 61/740,731, filed Dec. 21, 2012, entitled “FILE FORMAT AND PLATFORM FOR STORAGE AND VERIFICATION OF CREDENTIALS”, which is hereby incorporated by reference in its entirety.

### BACKGROUND

The rapid growth and evolution of traditional and electronic commerce markets has resulted in wide-spread demand for monetary payments by digital transactions. Current payment systems are highly fragmented and fail to provide necessary analytical information to users and merchants. Current systems fail to provide necessary controls for limiting digital payments.

Additionally, as more individuals move away from traditional forms of advertising, such as print advertising, merchants may be unable to identify and target advertisements to persons most likely respond to the advertisement. Current forms of non-cash payments, such as gift cards or credit cards, fail to provide an effective method for targeting advertisements and competing for business.

### SUMMARY

In various embodiments, a computer-implemented method for providing an intent to spend analytics platform is disclosed. The computer-implemented method comprises receiving, by a processor configured to execute a pre-commerce screening engine, one or more parameters of a payment instrument. The computer-implemented method further comprises generating, by the processor, one or more targeted offers based on the one or more parameters of the payment instrument.

In various embodiments, a computer-implemented method for implementing an intent to spend analytics platform is disclosed. The computer-implemented method comprises receiving, by a processor configured to execute a pre-commerce screening engine, analytical data associated with a user. The method further comprises generating, by the processor, one or more targeted offers based on the analytical data associated with the user.

In various embodiments, an apparatus for providing an intent to spend analytics platform is disclosed. The apparatus comprises a processor and a memory unit operatively coupled to the processor. The memory unit is configured to store a plurality of instructions. The plurality of instructions is configured to program the processor to execute a pre-commerce screening engine. The processor is programmed to receive one or more parameters of a payment instrument and generate one or more targeted offers based on the one or more parameters of the payment instrument.

### FIGURES

The features of the various embodiments are set forth with particularity in the appended claims. The various embodiments, however, both as to organization and methods of operation, together with advantages thereof, may best be understood by reference to the following description, taken in conjunction with the accompanying drawings as follows:

FIG. 1 illustrates one embodiment of an intent to spend analytics platform.

FIG. 2 illustrates one embodiment of a virtual wallet platform.

FIG. 3 illustrates one embodiment of a payment platform home display screen.

FIG. 4 illustrates one embodiment of a payment instrument summary screen.

FIG. 5 illustrates one embodiment of a Near Field Communication payment screen.

FIG. 6 illustrates one embodiment of a scannable information code payment screen.

FIG. 7 illustrates one embodiment of a payment instrument generation screen.

FIG. 8 illustrates one embodiment of a payment instrument restriction screen.

FIG. 9 illustrates one embodiment of a payment instrument delivery screen.

FIG. 10 illustrates one embodiment of payment instrument recent transaction screen.

FIG. 11 illustrates one embodiment of a selected payment instrument recent transaction screen.

FIG. 12 illustrates one embodiment of a computing environment for implementing the intent to spend analytics platform.

### DESCRIPTION

In various embodiments, a computer-implemented method for providing an intent to spend analytics platform is disclosed. The computer-implemented method comprises receiving, by a processor configured to execute a pre-commerce screening engine, one or more parameters of a payment instrument. The computer-implemented method further comprises generating, by the processor, one or more targeted offers based on the one or more parameters of the payment instrument.

In various embodiments, a computer-implemented method for implementing an intent to spend analytics platform is disclosed. The computer-implemented method comprises receiving, by a processor configured to execute a pre-commerce screening engine, analytical data associated with a user. The method further comprises generating, by the processor, one or more targeted offers based on the analytical data associated with the user.

In various embodiments, an apparatus for providing an intent to spend analytics platform is disclosed. The apparatus comprises a processor and a memory unit operatively coupled to the processor. The memory unit is configured to store a plurality of instructions. The plurality of instructions is configured to program the processor to execute a pre-commerce screening engine. The processor is programmed to receive one or more parameters of a payment instrument and generate one or more targeted offers based on the one or more parameters of the payment instrument.

Reference will now be made in detail to several embodiments, including embodiments showing example implementations of systems and methods for providing an intent to spend analytics platform. Wherever practicable similar or like reference numbers may be used in the figures and may indicate similar or like functionality. The figures depict example embodiments of the disclosed systems and/or methods of use for purposes of illustration only. One skilled in the art will readily recognize from the following description that alternative example embodiments of the structures and methods illustrated herein may be employed without departing from the principles described herein.

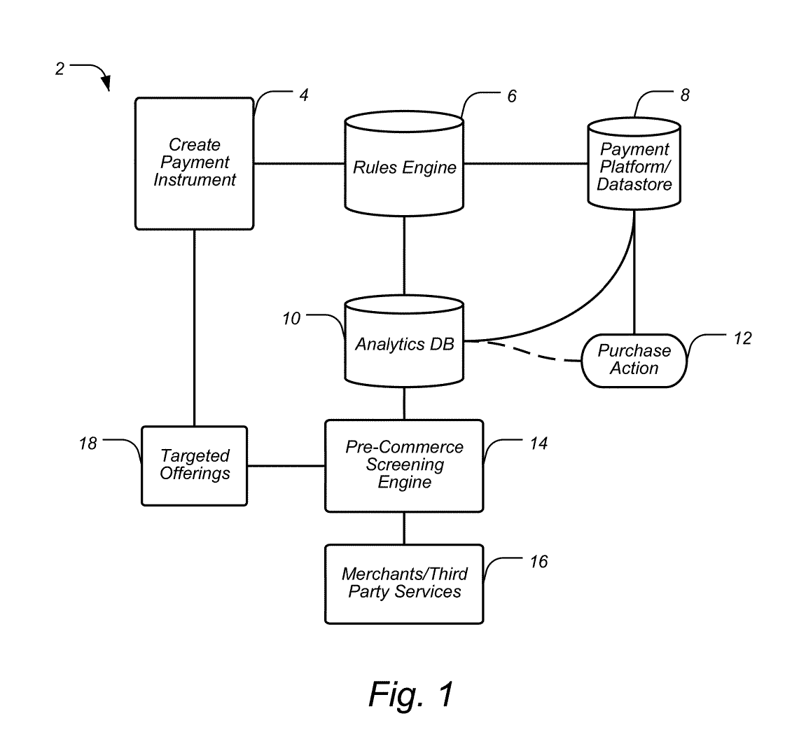

FIG. 1 illustrates one embodiment of an intent to spend analytics platform 2. The intent to spend analytics platform 2 may be configured to generate user generated payment instruments 4, such as, for example, a reducing currency denomination (RCD) payment instrument. A RCD payment platform is described in more detail in U.S. Patent App. Pub. No. 2009/0070268, entitled “SYSTEMS, METHODS, AND APPARATUSES FOR SECURE DIGITAL TRANSACTIONS,” published on Mar. 12, 2009, the disclosure of which is herein incorporated by reference in its entirety. The intent to spend analytics platform 2 may generate a user generated payment instrument 4 from any suitable source, such as, for example, by charging a credit card, debiting a bank account, accessing a gift card balance, points in a loyalty club account and/or receiving a payment instrument from a third party.

The intent to spend analytics platform 2 may comprise a rules engine 6. The rules engine 6 may be configured to generate one or more parameters or rules for a user generated payment instrument 4. The parameters may define the user generated payment instrument 4, such as, for example, by defining a value of the user generated payment instrument 4. The parameters may comprise one or more rules to limit the user generated payment instrument 4 to specific uses as described by the one or more rules. For example, in one embodiment, the rules engine 6 may generate one or more rules for a user generated payment instrument, such as: a limited total value of a single transaction; a limited total value of a plurality of transactions; a limited number of transactions per day; an expiration date; limiting the user generated payment instrument to a specific category of merchants; and/or limiting the user generated payment instrument to a specific set of merchants, for example, one or more merchants.

In one embodiment, the rules engine 6 may generate a user generated payment instrument 4 having a parameter defining a set total value. When the user generated payment instrument 4 has been used to purchase goods up to the set total value, the user generated payment instrument 4 may be deactivated or may be removed from a user platform, for example, a virtual wallet platform. For example, the rules engine 8 may generate a parameter of a user generated payment instrument 4 with a set value of $100. When the user generated payment instrument 4 has been used to pay for goods totaling $100, the user generated payment instrument 4 may be deactivated and no additional payments may be made using the user generated payment instrument 4.

In one embodiment, the rules engine 6 may generate a parameter limiting a user generated payment instrument to a maximum transaction value of a single transaction. The user generated payment instrument 4 may be limited to transactions less than the maximum transaction value. In some embodiments, a user may be unable to use the user generated payment instrument 4 in any transaction exceeding the limited value. In some embodiments, the user may be able to use the user generated payment instrument 4 up to the limited value and may provide a second payment instrument for the value exceeding the maximum transaction value of the user generated payment instrument. For example, in one embodiment, a user generated payment instrument 4 may be limited to a total transaction value of $50.00. If a user attempts to use the user generated payment instrument 4 for a transaction more than the maximum transaction value, for example, $60.00, the user may be limited to only the maximum transaction value limit of $50.00 and would need to provide a second form of payment, such as, for example, a second user generated payment instrument, for the remaining balance. As another example, the user may be unable to use the user generated payment instrument 4 for the $60.00 transaction, as the transaction exceeds the maximum transaction value of the user generated payment instrument 4.

In some embodiments, the rules engine 6 may generate a parameter limiting a user generated payment instrument 4 to a maximum number of transactions per day. The user generated payment instrument 4 may only be used to make a certain number of transactions up to the maximum number of transactions per day. For example, a user generated payment instrument 4 may be limited to a maximum of five transactions per day. If a user attempts to use the user generated payment instrument 4 to make a sixth payment, the rule will prevent the use of the user generated payment instrument 4.

In some embodiments, the rules engine 6 may generate a parameter limiting a user generated payment instrument to a specific time limit, such as, for example, by assigning an expiration date. The user generated payment instrument 4 may have to be used by the expiration date or else the balance of the user generated payment instrument 4 may be lost or revert back to the original source of the funds. In some embodiments, the rules engine 6 may generate a parameter limiting a user generated payment instrument 4 to one or more specific merchants or merchant categories. For example, a user generated payment instrument 4 may be limited to a specific type of merchant, such as, for example, grocery stores. As another example, a user generated payment instrument may be limited to use at a specific retailer, such as, for example, a specific grocery store chain. Although various parameters have been described above, those skilled in the art will recognize that the rules engine 6 may generate any suitable parameter for defining and/or limiting the use of a user generated payment instrument.

After generating one or more parameters for the user generated payment instrument 4, the intent to spend analytics engine 2 may store the user generated payment instrument 4. A payment platform 8, for example, a virtual wallet platform or a payment database, may store one or more user generated payment instruments 4. In some embodiments, the payment platform 8 may comprise a payment platform executed by a user device, such as, for example, virtual wallet platform executed by a user mobile device. In some embodiments, the payment platform 8 may comprise a payment database configured to store one or more user generated payment instruments 4 and accessible over a communication network, such as, for example, the Internet. The payment platform 8 may store the one or more user generated payment instruments 4 as well as the one or more parameters generated for each user generated payment instrument 4. The payment platform 8 may store additional information for each user generated payment instrument 4, such as, for example, a current balance, usage history, or targeted offers associated with the user generated payment instrument 4.

In some embodiments, the rules engine 6 and/or the payment platform 8 may be in communication with an analytics datastore 10, such as, for example, a database. The analytics datastore 10 may be configured to store the parameters generated by the rules engine and/or information about the user generated payment instruments 4 stored in the payment platform 8. In some embodiments, the analytics datastore 10 may store user information regarding purchase history, previous purchases, and/or other relevant analytical information associated with one or more users. In some embodiments, the analytics datastore 10 may receive data from one or more purchase actions 12, such as, for example, the merchant, class of merchant, amount, time, and/or type of purchase made using a payment instrument. The purchase action may be associated with a specific targeted offer 18 received by a user. The analytics datastore 10 may receive information related to a targeted offer 18 and may generate analytical information related to the targeted offer 18, such as, for example, a success rate of the targeted offer 18.

The analytics datastore 10 may be accessible by a pre-commerce screening engine 14. The pre-commerce screening engine 14 may be configured to access the analytics datastore 10 and generate one or more targeted offers 18. A targeted offer 18 may comprise an offer generated by a merchant 16 accessing the pre-commerce screening engine 14 that matches one or more parameters for a user generated payment instrument 4 and/or analytical data corresponding to one or more users. For example, in one embodiment, a user generated payment instrument 4 may be limited to a specific class of merchants. A merchant 16 within the class of merchants may receive information from the analytics datastore 10 indicating that a user generated payment instrument 4 exists that is limited to the merchant's 16 class. The merchant 16 may access the pre-commerce screening engine 16 to generate an offer, such as an advertisement, to be sent to one or more users having payment instruments limited to the merchant class of the merchant.

In some embodiments, the pre-commerce screening engine 14 may provide screened data to one or more merchants/third party services 16. Screened data may comprise analytical data that has had user personal information removed from the data. For example, the pre-commerce screening engine 14 may provide screened data without providing user names, locations, financial information, and/or other personal and/or sensitive information. In some embodiments, the analytics datastore 10 and/or the pre-commerce screening engine 14 may comprise one or more anonymous screening filters configured to screen the data contained in the analytics datastore 10 to ensure user privacy while still providing enough information to generate relevant offers and analytical data. Merchants 16 (or other third-party services) may access the pre-commerce screening engine 14 to generate one or more offers based on the anonymous user data provided by the analytics datastore 10. In some embodiments, the screened data may add filters defined by the user, for example, to remove offers by merchants, merchant categories, price ranges, date ranges, number of offers within a category or timeframe, payment mechanisms, or other types of offer attributes.

The merchants and/or third party services 16 may access the data provided by the analytics datastore 10 through the pre-commerce screening engine 14 to generate one or more targeted offers 18. As discussed above, a targeted offer 18 may comprise an offer sent to one or more users meeting a specific criteria, such as, for example, users having a payment instrument limited to a specific class of merchants or a user with a history of transactions at a specific merchant. Targeted offers 18 may be delivered by the intent to spend analytics platform 2 to a user, such as, for example, by sending a targeted offer 18 to one or more user devices. In one embodiment, a user may opt-in to receive targeted offers 18 from the intent to spend analytics platform 2. For example, in some embodiments, a user may access a virtual wallet platform on a user device and may access available targeted offers 18 directed to the user. In some embodiments, one or more targeted offers 18 may be stored in by the payment platform 8 and may be presented to a user when the user accesses a payment instrument through the payment platform 8. A user may choose to use a payment instrument at a specific merchant or third party service based on the targeted offers 18. In some embodiments, the pre-commerce screening engine 14 may allow merchants 16 to analyze the buying history of one or more users and the effectiveness of targeted offers 18 directed to the one or more users.

In some embodiments, the analytics datastore 10 may receive and store data indicating the success of targeted offers 18 generated by one or more merchants. For example, the analytics datastore 10 may receive data indicating that a user viewed a targeted offer for a specific merchant 16 and subsequently engaged in a transaction with the merchant 16 using a payment instrument. The analytics datastore 10 may receive the details of the targeted offer 18 delivered to the user and may indicate the targeted offer 18 was a successful offer for one or more users. In some embodiments, the analytics datastore 10 may store purchase information for one or more users unrelated to a targeted offer 18. For example, the analytics datastore 10 may periodically receive all purchase activity for a user. The purchase activity may be provided to the pre-commerce screening engine 14 for generating or matching targeted offers 18 to the user.

In some embodiments, the pre-commerce screening engine 14 may provide analytical information to one or more merchants/third party services 16 identifying a success or failure rate of targeted offers. For example, the pre-commerce screening engine 14 may provide information indicating the number of targeted offers 18 sent by the merchant 16, the number of users that received the targeted offers 18, and the number of users that subsequently engaged in a transaction with the merchant 16. The merchant 16 may use the analytical information related to the success or failure of one or more targeted offers 18 to generate targeted offers 18 that are statistically more likely to be successful.

In some embodiments, the pre-commerce screening engine 14 may store a targeted offer 18 generated by a merchant 16. The pre-commerce screening engine 14 may identify users or payment instruments that match the criteria of the targeted offer 18 but that have not receive the targeted offer 18, for example, because the payment instrument was generated after the targeted offer 18 was generated by the pre-commerce screening engine 14. The pre-commerce screening engine 14 may automatically transmit the targeted offer 18 to the identified user or payment instruments that match the targeted offer 18 criteria but have not previously received the targeted offer 18.

In some embodiments, the analytical datastore 10 and/or the pre-commerce screening engine 14 may provide analytical data to merchants 16 identifying one or more users who have generated user generated payment instruments. For example, the pre-commerce screening engine may identify a user who generates multiple user generated payment instruments for a specific class of merchants. A merchant 16 may receive analytical information about the user and may use the pre-commerce screening engine 14 to generate one or more targeted offers 18 for the user. The one or more targeted offers 18 may provide an incentive to the user to create user generated payment instruments limited to, for example, a specific merchant within the class of merchants, a narrower class of merchants, or a different class of merchants.

In some embodiments, the intent to spend analytics platform 2 may be in communication with and/or integrated with a virtual wallet platform. A virtual wallet platform may provide a user with access to payment instruments and information related to the payment instruments. For example, the virtual wallet platform may provide a platform for receiving and/or responding to targeted offers 18 provided by one or more merchants.

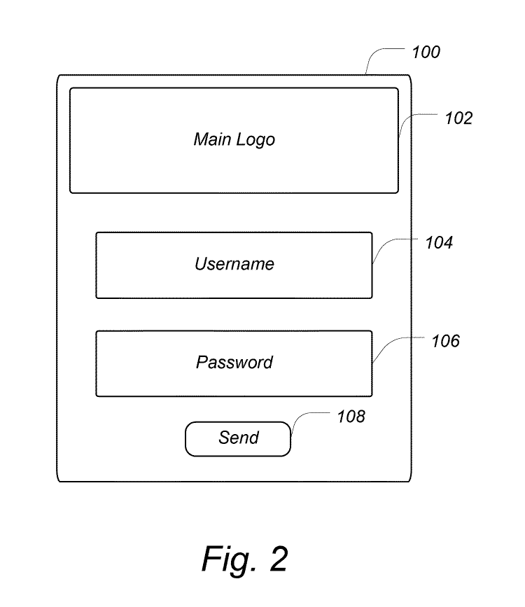

FIG. 2 illustrates one embodiment of a virtual wallet platform 100. The virtual wallet platform may provide an electronic platform for accessing payment instruments and/or credential storage. The virtual wallet platform 100 may provide an electronic replacement for credit cards, cash, identification, and/or other cards traditionally carried in a wallet. In some embodiments, the virtual wallet platform may provide a user generated payment instrument platform, such as the RCD payment platform discussed above, and/or a credential storage client. A credential storage client is described in more detail in U.S. patent application Ser. No. 13/794,878, entitled “FILE FORMAT AND PLATFORM FOR STORAGE AND VERIFICATION OF CREDENTIALS,” which was filed on Mar. 12, 2013, the disclosure of which is incorporated by reference herein in its entirety. In some embodiments, the payment platform may be in communication with an intent to spend analytics platform 2. FIG. 2 illustrates a logon screen for a virtual wallet platform 100. In some embodiments, the virtual wallet platform 100 may require a username 104 and a password 106 be provided prior to accessing the payment platform or the credential platform. After entering a username 104 and password 106, a user may submit the username 104 and password 106 for verification using a send button 108. The username 104 and password 106 may be verified by a local processor and memory or may be sent to a remote server for verification. The logon screen may comprise a logo 102 of the virtual wallet platform 100.

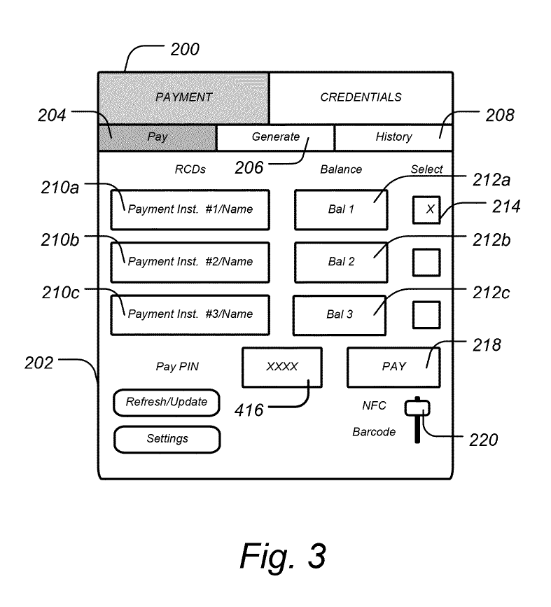

FIGS. 3-11 illustrate one embodiment of a payment platform 200 included as part of the virtual wallet platform 100. The payment platform 200 may enable a user to pay for goods or services using a mobile computing platform comprising the virtual wallet platform 100. The payment platform 200 may provide for payment instrument generation and/or management. The payment platform 200 may be connected to an intent to spend analytics platform 2. The payment platform 200 may comprise a payment function 204, a generation function 206, and a history function 208. The payment platform 200 may be configured to store one or more payment instruments, track one or more payment instruments, and provide targeted offers associated with one or more payment instruments.

FIG. 3 illustrates one embodiment of a payment screen 202. The payment screen 202 may allow a user to select one or more payment instruments 210a-210c. The one or more payment instruments 210a-210c may each have an associated balance 212a-212c indicating the remaining funds available for payment using the payment instrument 210a-210c. A user may select one of the Payment instruments 210a-210c using a provided selection box 214. In order to authorize payment using a payment instrument 210a, a user may be required to provide a payment personal identification number (PIN) 216 associated with the RCD payment platform 200 before submitting the a payment using a payment button 218. In some embodiments, a user may be able to select the delivery system for the payment using a slider 220. For example, a user may be able to select between Near Field Communication (NFC) and/or barcode scanning for providing the payment instrument 210a to a merchant. In some embodiments, the payment screen 202 may indicate that on or more targeted offers have been received for the displayed payment instruments 210a-210c.

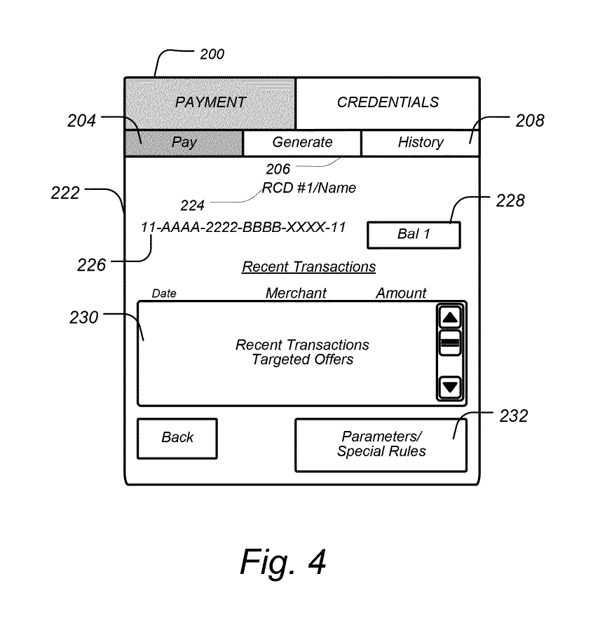

FIG. 4 illustrates one embodiment of a payment instrument summary screen 222. The payment instrument summary screen 222 may provide the name 224, current balance 228 and relevant information 230 for the selected payment instrument, such as, for example, payment instrument 210a. The relevant information 230 may comprise, for example, recent transaction history, received targeted offers, and/or analytical data associated with the payment instrument. Each payment instrument 210a-210c may have an associated security code 226. The selected payment instrument 210a may comprise one or more parameters or rules 232. In some embodiments, the one or more parameters 232 may be generated by a rules engine 6 during generation of the payment instrument 210a. The one or more parameters 232 may be stored with the payment instrument 210a and may limit the payment instrument 210a, such as, for example, limiting the payment instrument 210a to specific retailers, specific transactional limits (including amount limits and number of transaction limits), and/or specific items. In some embodiments, the one or more parameters 232 may be displayed on the payment instrument summary screen 222.

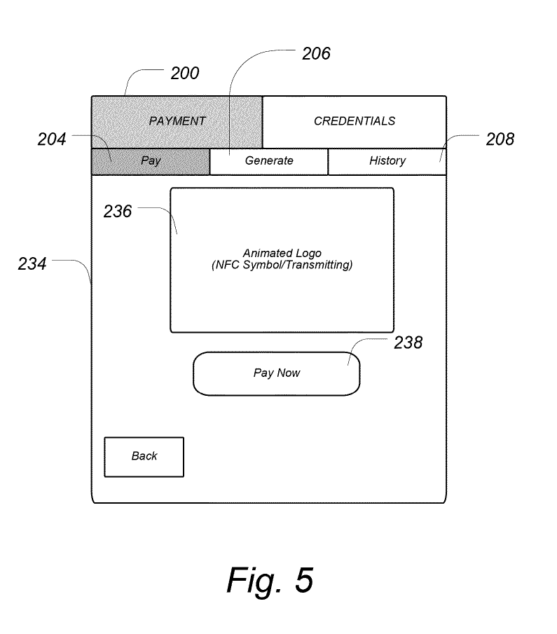

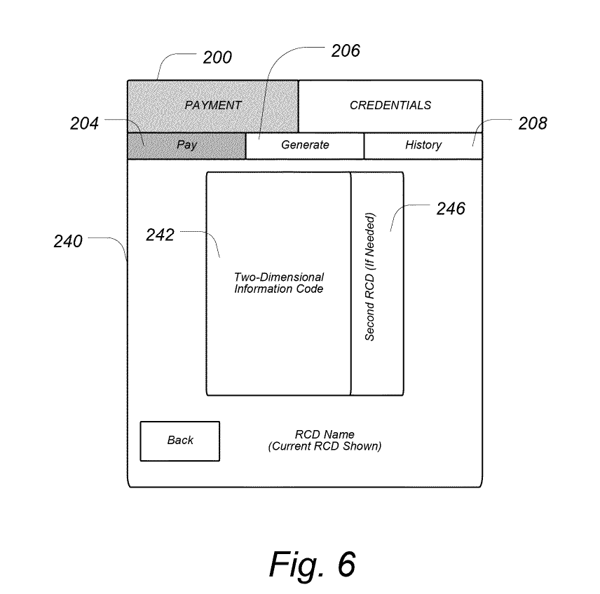

FIGS. 5 and 6 illustrate various embodiments of payment authorization screens. FIG. 5 illustrates a Near Field Communication (NFC) payment authorization screen 234. When selecting a NFC payment, a user may be presented with a NFC logo 236 indicating that a NFC payment has been selected by the user. A payment button 238 may be provided to activate the NFC payment and transmit the payment information using NFC to a merchant system configured to receive NFC payments. FIG. 6 illustrates an information code payment authorization screen 240. In some embodiments, an information code 242 may be generated containing payment instrument information. The information code 242 may be displayed on a user device, such as, for example, a user mobile device, and may be scanned by a merchant to obtain the payment instrument information. A second payment instrument 246 may be provided if the payment instrument associated with the generated information code 242 is insufficient to complete the transaction. For example, one or more parameters may limit the payment instrument associated with the information code 242 to a value less than the total value of the transaction. The two-dimensional information code 242 may comprise, for example, a barcode or a quick response (QR) code.

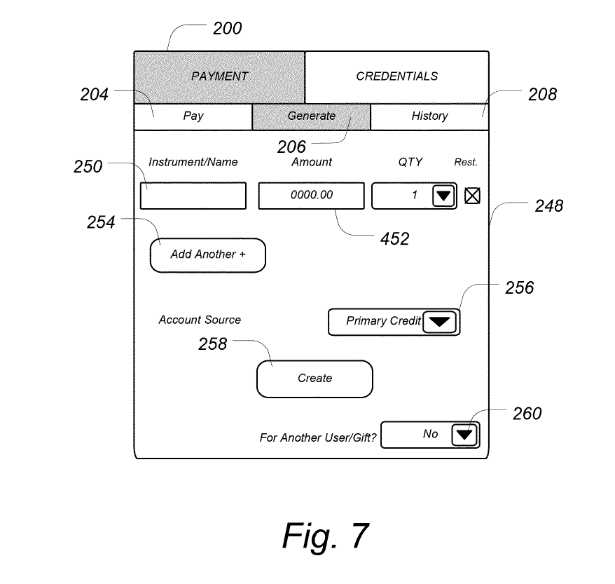

FIGS. 7-9 illustrate one embodiment of a payment platform 200 configured to generate a user generated payment instrument. As shown in FIG. 7, when a user selects the generation function 206, the user may be presented with a payment instrument input screen 248. The payment instrument input screen 248 may comprise one or more input boxes to allow a user to enter the necessary information for generating a payment instrument. For example, a user may be provided with a payment instrument name box 250, a payment instrument amount box 252, and an account source box 256. The name box 250 may allow a user to define a custom name for the entered payment instrument. The amount box 252 may allow a user to define a value parameter for the user generated payment instrument. For example, a user may input $1,000 into the amount box 252, indicating that the user generated payment instrument is limited to a value of $1,000. After entering the required payment instrument information, the user may create the payment instrument using the create button 258. A user may generate multiple payment instruments using the same account source 256 by selecting the add another button 254. During the generation of the payment instrument, a user may access the rule engine 6 to generate one or more parameters for the user generated payment instrument.

In some embodiments, the payment instrument input screen 248 may display one or more targeted offers received by the payment platform 200 associated with the creation of user generated payment instruments. For example, the payment instrument input screen 248 may indicate that a merchant has provided a targeted offer that provides an additional $10.00 of value if the user creates a user generated payment instrument limited to the specific merchant. The payment instrument input screen 248 may also display targeted offers associated with user generated payment instruments that have been recently generated by the user. The user may choose to generate additional payment instruments matching the parameters of the provided targeted offers.

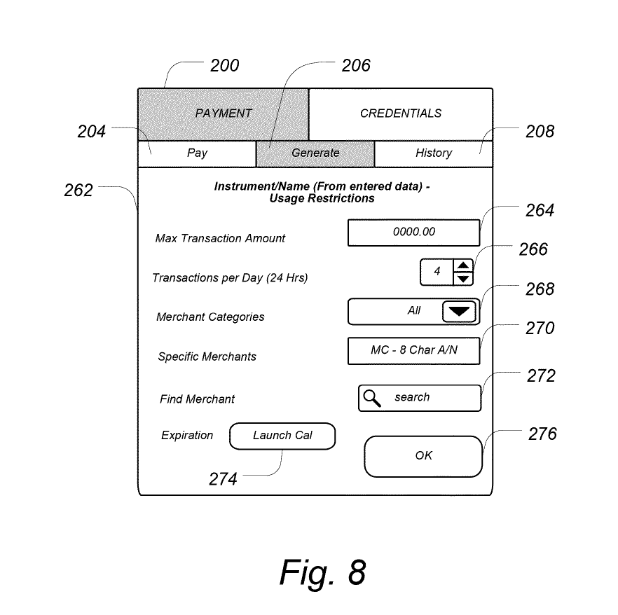

FIG. 8 shows one embodiment of a usage restriction screen 262 for defining one or more parameters of a user generated payment instrument. The usage restriction screen 262 may be populated by contacting a rules engine 6. The rules engine 6 may provide one or more selections for defining parameters associated with the user generated payment instrument. For example, a user may define a maximum transaction amount 264 or a maximum transactions per day count 266. The user may limit the types of merchants 268 at which the payment instrument may be used, for example, limiting a payment instrument to only grocery stores. The user may define a specific merchant 270 at which the payment instrument may be used. A search box 272 may allow the user to search for a specific merchant 270 by name or category. The user may further define an expiration date 274 for the payment instrument. After a user has entered all of the payment instrument restrictions, the user may save the restrictions using a button 276. In some embodiments, the payment platform 200 may be in communication with the rules engine 6. The payment platform 200 may send the selected restrictions to the rules engine 6. The rules engine 6 may generate and associate one or more rules with the user generated payment instrument.

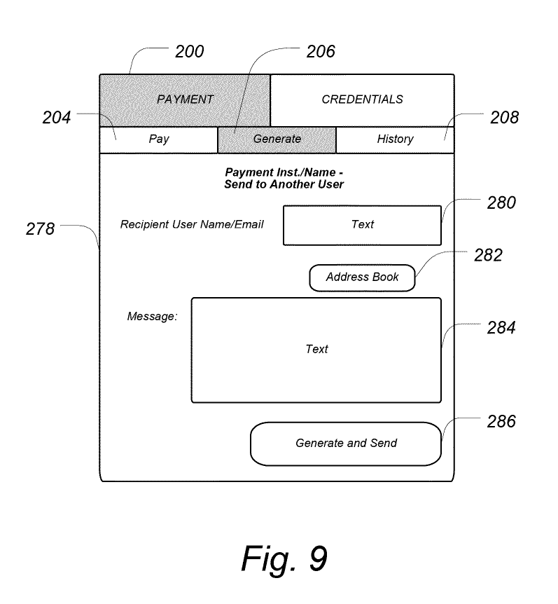

FIG. 9 illustrates one embodiment of a gift screen 278 for transmitting a user generated payment instrument to a third party. The gift screen 278 may provide a recipient box 280 for defining the recipient of the payment instrument. An address book button 282 may allow a user to look up a specific recipient from the user's address book stored on the user's device. A personalized message may be entered into the message box 284 by the user to be delivered with the generated payment instrument to the recipient. A send button 286 provides delivery of the generated payment instrument to the recipient. In some embodiments, the generated payment instrument may be stored by a payment platform, such as, for example, the payment platform 8.

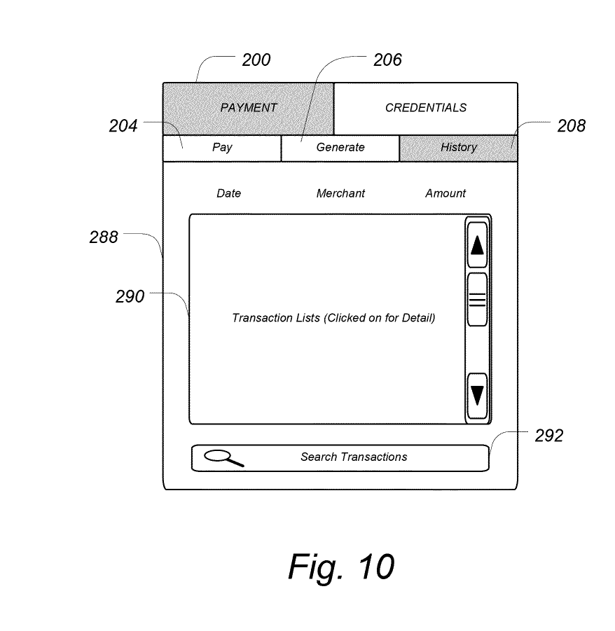

FIG. 10 illustrates one embodiment of a transaction history screen 288. The transaction history screen 288 may comprise a transaction history list 290. The transaction history list 290 may be configured to display a list of recent transactions performed using the payment platform 200. The transaction history list 290 may display targeted offers received by the payment platform 200. The transaction history list 290 may indicate whether a user took advantage of a specific targeted offer. A search box 292 may allow a user to search for a specific transactions or targeted offers, such as, for example, all transactions performed using, or targeted offer associate with, a specific payment instrument. In some embodiments, the transaction history screen 288 may be generated from data stored in the analytic datastore 10, such as, for example, previous purchases made with a specific payment instrument or stored targeted offer data. The specific transaction history may be provided to the analytic datastore 10 and the pre-commerce screening engine 14. The pre-commerce screening engine 14 may utilize the transaction history of a user to generate one or more targeted offers 18 for that user.

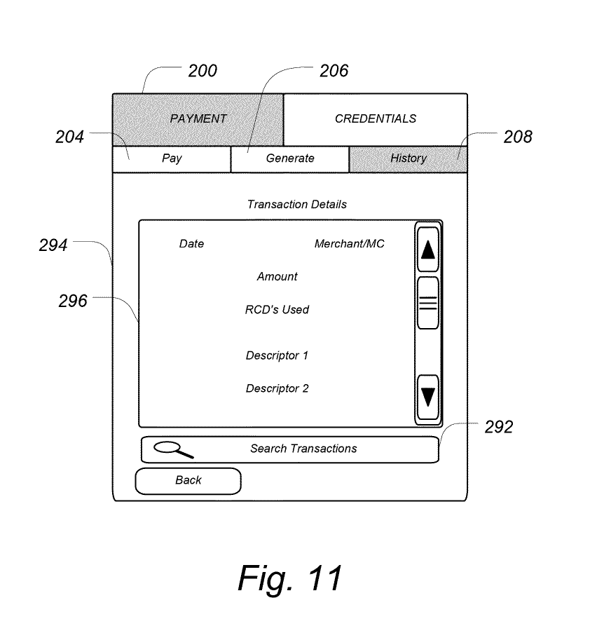

FIG. 11 illustrates one embodiment of a transaction history screen 294. The transaction history screen 294 may provide specific information regarding a transaction performed by the payment platform 200. The transaction history screen 294 may comprise a transaction history box 296 configured to provide details of a selected transaction, such as, for example, the date of the transaction, the merchant or location of the transaction, the amount of the transaction, the payment instrument used in the transaction, whether the transaction was related to a targeted offer, and/or one or more descriptors for the transaction, such as the goods purchased or the type of merchant. In some embodiments, the transaction history screen 294 may be generated from information stored in the analytics datastore 10. In some embodiments, the payment platform 200 may provide the details of a selected transaction to the analytics datastore 10. The analytics datastore may provide the details of the selected transaction, in an anonymous format, to the pre-commerce screening engine 14 for generation of one or more targeted offers 18.

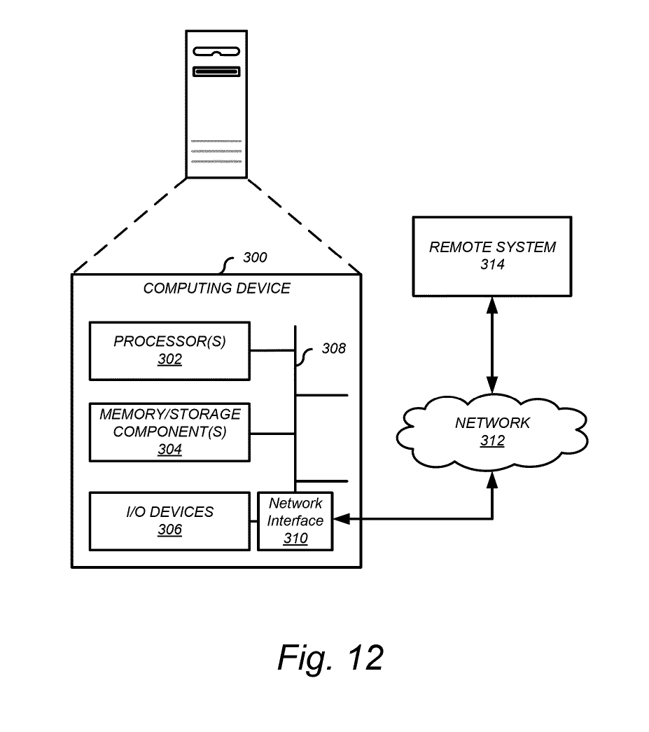

FIG. 12 illustrates one embodiment of a computing device 300 which can be used in one embodiment of the system and method for providing an intent to spend analytics platform. For the sake of clarity, the computing device 300 is shown and described here in the context of a single computing device. It is to be appreciated and understood, however, that any number of suitably configured computing devices can be used to implement any of the described embodiments. For example, in at least some implementation, multiple communicatively linked computing devices are used. One or more of these devices can be communicatively linked in any suitable way such as via one or more networks (LANs), one or more wide area networks (WANs) or any combination thereof.

In this example, the computing device 300 comprises one or more processor circuits or processing units 302, on or more memory circuits and/or storage circuit component(s) 304 and one or more input/output (I/O) circuit devices 306. Additionally, the computing device 300 comprises a bus 308 that allows the various circuit components and devices to communicate with one another. The bus 308 represents one or more of any of several types of bus structures, including a memory bus or local bus using any of a variety of bus architectures. The bus 308 may comprise wired and/or wireless buses.

The processing unit 302 may be responsible for executing various software programs such as system programs, applications programs, and/or module to provide computing and processing operations for the computing device 300. The processing unit 302 may be responsible for performing various voice and data communications operations for the computing device 300 such as transmitting and receiving voice and data information over one or more wired or wireless communication channels. Although the processing unit 302 of the computing device 300 includes single processor architecture as shown, it may be appreciated that the computing device 300 may use any suitable processor architecture and/or any suitable number of processors in accordance with the described embodiments. In one embodiment, the processing unit 300 may be implemented using a single integrated processor.

The processing unit 302 may be implemented as a host central processing unit (CPU) using any suitable processor circuit or logic device (circuit), such as a as a general-purpose processor. The processing unit 302 also may be implemented as a chip multiprocessor (CMP), dedicated processor, embedded processor, media processor, input/output (I/O) processor, co-processor, microprocessor, controller, microcontroller, application specific integrated circuit (ASIC), field programmable gate array (FPGA), programmable logic device (PLD), or other processing device in accordance with the described embodiments.

As shown, the processing unit 302 may be coupled to the memory and/or storage component(s) 304 through the bus 308. The memory bus 308 may comprise any suitable interface and/or bus architecture for allowing the processing unit 302 to access the memory and/or storage component(s) 304. Although the memory and/or storage component(s) 304 may be shown as being separate from the processing unit 302 for purposes of illustration, it is worthy to note that in various embodiments some portion or the entire memory and/or storage component(s) 304 may be included on the same integrated circuit as the processing unit 302. Alternatively, some portion or the entire memory and/or storage component(s) 304 may be disposed on an integrated circuit or other medium (e.g., hard disk drive) external to the integrated circuit of the processing unit 302. In various embodiments, the computing device 300 may comprise an expansion slot to support a multimedia and/or memory card, for example.

The memory and/or storage component(s) 304 represent one or more computer-readable media. In some embodiments, the computer-readable media may comprise non-transitory computer readable-media. The memory and/or storage component(s) 304 may be implemented using any computer-readable media capable of storing data such as volatile or non-volatile memory, removable or non-removable memory, erasable or non-erasable memory, writeable or re-writeable memory, and so forth. The memory and/or storage component(s) 304 may comprise volatile media (e.g., random access memory (RAM)) and/or nonvolatile media (e.g., read only memory (ROM), Flash memory, optical disks, magnetic disks and the like). The memory and/or storage component(s) 304 may comprise fixed media (e.g., RAM, ROM, a fixed hard drive, etc.) as well as removable media (e.g., a Flash memory drive, a removable hard drive, an optical disk, etc.). Examples of computer-readable storage media may include, without limitation, RAM, dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory, ovonic memory, ferroelectric memory, silicon-oxide-nitride-oxide-silicon (SONOS) memory, magnetic or optical cards, or any other type of media suitable for storing information.

The one or more I/O devices 306 allow a user to enter commands and information to the computing device 300, and also allow information to be presented to the user and/or other components or devices. Examples of input devices include a keyboard, a cursor control device (e.g., a mouse), a microphone, a scanner, biometric sensors, and the like. Examples of output devices include a display device (e.g., a monitor or projector, speakers, a printer, a network card, etc.). The computing device 300 may comprise an alphanumeric keypad coupled to the processing unit 302. The keypad may comprise, for example, a QWERTY key layout and an integrated number dial pad. The computing device 300 may comprise a display coupled to the processing unit 302. The display may comprise any suitable visual interface for displaying content to a user of the computing device 4000. In one embodiment, for example, the display may be implemented by a liquid crystal display (LCD) such as a touch-sensitive color (e.g., 76-bit color) thin-film transistor (TFT) LCD screen. The touch-sensitive LCD may be used with a stylus and/or a handwriting recognizer program.

The processing unit 302 may be arranged to provide processing or computing resources to the computing device 300. For example, the processing unit 302 may be responsible for executing various software programs including system programs such as operating system (OS) and application programs. System programs generally may assist in the running of the computing device 300 and may be directly responsible for controlling, integrating, and managing the individual hardware components of the computer system. The OS may be implemented, for example, as a Microsoft® Windows OS, Symbian OS™, Embedix OS, Linux OS, Binary Run-time Environment for Wireless (BREW) OS, JavaOS, Android OS, Apple OS or other suitable OS in accordance with the described embodiments. The computing device 300 may comprise other system programs such as device drivers, programming tools, utility programs, software libraries, application programming interfaces (APIs), and so forth.

The computer 300 also includes a network interface 310 coupled to the bus 308. The network interface 310 provides a two-way data communication coupling to a local network 312. For example, the network interface 310 may be a digital subscriber line (DSL) modem, satellite dish, an integrated services digital network (ISDN) card or other data communication connection to a corresponding type of telephone line. As another example, the communication interface 310 may be a local area network (LAN) card effecting a data communication connection to a compatible LAN. Wireless communication means such as internal or external wireless modems may also be implemented.

In any such implementation, the network interface 310 sends and receives electrical, electromagnetic or optical signals that carry digital data streams representing various types of information, such as the selection of goods to be purchased, the information for payment of the purchase, or the address for delivery of the goods. The network interface 310 typically provides data communication through one or more networks to other data devices. For example, the network interface 310 may effect a connection through the local network to an Internet Host Provider (ISP) or to data equipment operated by an ISP. The ISP in turn provides data communication services through the internet (or other packet-based wide area network). The local network and the internet both use electrical, electromagnetic or optical signals that carry digital data streams. The signals through the various networks and the signals on the network interface 310, which carry the digital data to and from the computer system 400, are exemplary forms of carrier waves transporting the information.

The computer 300 can send messages and receive data, including program code, through the network(s) and the network interface 310. In the Internet example, a server might transmit a requested code for an application program through the internet, the ISP, the local network (the network 312) and the network interface 310. In accordance with the present disclosure, one such downloaded application provides for the identification and analysis of a prospect pool and analysis of marketing metrics. The received code may be executed by processor 304 as it is received, and/or stored in storage device 310, or other non-volatile storage for later execution. In this manner, computer 300 may obtain application code in the form of a carrier wave.

Various embodiments may be described herein in the general context of computer executable instructions, such as software, program modules, and/or engines being executed by a computer. Generally, software, program modules, and/or engines include any software element arranged to perform particular operations or implement particular abstract data types. Software, program modules, and/or engines can include routines, programs, objects, components, data structures and the like that perform particular tasks or implement particular abstract data types. An implementation of the software, program modules, and/or engines components and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, program modules, and/or engines may be located in both local and remote computer storage media including memory storage devices.

Although some embodiments may be illustrated and described as comprising functional components, software, engines, and/or modules performing various operations, it can be appreciated that such components or modules may be implemented by one or more hardware components, software components, and/or combination thereof. The functional components, software, engines, and/or modules may be implemented, for example, by logic (e.g., instructions, data, and/or code) to be executed by a logic device (e.g., processor). Such logic may be stored internally or externally to a logic device on one or more types of computer-readable storage media. In other embodiments, the functional components such as software, engines, and/or modules may be implemented by hardware elements that may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Examples of software, engines, and/or modules may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some cases, various embodiments may be implemented as an article of manufacture. The article of manufacture may include a computer readable storage medium arranged to store logic, instructions and/or data for performing various operations of one or more embodiments. In various embodiments, for example, the article of manufacture may comprise a magnetic disk, optical disk, flash memory or firmware containing computer program instructions suitable for execution by a general purpose processor or application specific processor. The embodiments, however, are not limited in this context.

The functions of the various functional elements, logical blocks, modules, and circuits elements described in connection with the embodiments disclosed herein may be implemented in the general context of computer executable instructions, such as software, control modules, logic, and/or logic modules executed by the processing unit. Generally, software, control modules, logic, and/or logic modules comprise any software element arranged to perform particular operations. Software, control modules, logic, and/or logic modules can comprise routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some embodiments also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the embodiments described herein illustrate example implementations, and that the functional elements, logical blocks, modules, and circuits elements may be implemented in various other ways which are consistent with the described embodiments. Furthermore, the operations performed by such functional elements, logical blocks, modules, and circuits elements may be combined and/or separated for a given implementation and may be performed by a greater number or fewer number of components or modules. As will be apparent to those of skill in the art upon reading the present disclosure, each of the individual embodiments described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one embodiment” or “an embodiment” means that a particular feature, structure, or characteristic described in connection with the embodiment is comprised in at least one embodiment. The appearances of the phrase “in one embodiment” or “in one aspect” in the specification are not necessarily all referring to the same embodiment.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, also may mean that two or more elements are not in direct contact with each other, but yet still co-operate or interact with each other. With respect to software elements, for example, the term “coupled” may refer to interfaces, message interfaces, application program interface (API), exchanging messages, and so forth.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits ASICs, FPGAs, DSPs, or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, non-transitory medium, transmitting computer, receiving computer, etc. located outside the territory).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

In summary, numerous benefits have been described which result from employing the concepts described herein. The foregoing description of the one or more embodiments has been presented for purposes of illustration and description. It is not intended to be exhaustive or limiting to the precise form disclosed. Modifications or variations are possible in light of the above teachings. The one or more embodiments were chosen and described in order to illustrate principles and practical application to thereby enable one of ordinary skill in the art to utilize the various embodiments and with various modifications as are suited to the particular use contemplated. It is intended that the claims submitted herewith define the overall scope.

Various aspects of the subject matter described herein are set out in the following numbered clauses:

1. A computer-implemented method for providing an intent to spend analytics platform, the method comprising: receiving, by a processor configured to execute a pre-commerce screening engine, one or more parameters of a payment instrument; and generating, by the processor, one or more targeted offers based on the one or more parameters of the payment instrument.

2. The computer-implemented method of clause 1, comprising transmitting, by the processor, the one or more targeted offers to a user device.

3. The computer-implemented method of clause 1, comprising: identifying, by the processor, at least one additional payment instrument comprising the one or more parameters of the payment instrument; and transmitting, by the processor, the one or more targeted offers to at least one user device associated with the at least one additional payment instrument.

4. The computer-implemented method of clause 1, comprising receiving, by the processor, the one or more parameters comprising one or more rules, wherein the one or more rules limit use of the payment instrument.

5. The computer-implemented method of clause 4, comprising: receiving, by the processor, a rule limiting the payment instrument to a specific class of merchants; and generating, by the processor, a targeted offer for the specific class of merchants.

6. The computer-implemented method of clause 4, comprising: receiving, by the processor, a rule limiting the payment instrument to a specific merchant; and generating, by the processor, a targeted offer for the specific merchant.

7. The computer-implemented method of clause 1, comprising: receiving, by the processor, analytical data; and generating, by the processor, the one or more targeted offers based on the analytical data.

8. The computer-implemented method of clause 7, comprising receiving, by the processor, analytical data representative of a purchase action associated with the payment instrument.

9. The computer-implemented method of clause 7, comprising receiving, by the processor, analytical data associated with the one or more targeted offers, wherein the analytical data associated with the one or more targeted offers indicates a success of the targeted offer.

10. The computer-implemented method of clause 7, comprising providing, by the processor, screened analytical data to a merchant.

11. A computer-implemented method for implementing an intent to spend analytics platform, the method comprising: receiving, by a processor configured to execute a pre-commerce screening engine, analytical data associated with a user; and generating, by the processor, one or more targeted offers based on the analytical data associated with the user.

12. The computer-implemented method of clause 11, comprising receiving, by the processor, analytical data comprising one or more parameters of a payment instrument associated with the user.

13. The computer-implemented method of clause 11, comprising receiving, by the processor, analytical data comprising transaction history associated with the user.

14. The computer implemented method of clause 11, comprising transmitting, by the processor, the one or more targeted offers to a user device associated with the user.

15. An apparatus for providing an intent to spend analytics platform, the apparatus comprising: a processor; and a memory unit operatively coupled to the processor, wherein the memory unit is configured to store a plurality of instructions, and wherein the plurality of instructions is configured to program the processor to execute a pre-commerce screening engine to: receive one or more parameters of a payment instrument; and generate one or more targeted offers based on the one or more parameters of the payment instrument.

16. The apparatus of clause 15, wherein the instructions further program the processor to transmit the one or more targeted offers to a user device.

17. The apparatus of clause 15, wherein the instructions further program the processor to: identify at least one additional payment instrument comprising the one or more parameters of the payment instrument; and transmit the one or more targeted offers to at least one user device associated with the at least one additional payment instrument.

18. The apparatus of clause 15, wherein the instructions further program the processor to: receive analytical data; and generate the one or more targeted offers based on the analytical data.

19. The apparatus of clause 18, wherein the analytical data is representative of a purchase action associated with the payment instrument.

20. The apparatus of clause 18, wherein the analytical data is associated with the one or more targeted offers, and wherein the analytical data associated with the one or more targeted offers indicates a success of the targeted offer.

21. The apparatus of clause 18, wherein the instructions further program the processor to provide screened analytical data to a merchant.

What is claimed is:

1. A computer-implemented method for providing an intent to spend analytics platform, the method comprising:
receiving, by a processor configured to execute a pre-commerce screening engine, one or more parameters of a payment instrument; and
generating, by the processor, one or more targeted offers based on the one or more parameters of the payment instrument.

2. The computer-implemented method of claim 1, comprising transmitting, by the processor, the one or more targeted offers to a user device.

3. The computer-implemented method of claim 1, comprising:
identifying, by the processor, at least one additional payment instrument comprising the one or more parameters of the payment instrument; and
transmitting, by the processor, the one or more targeted offers to at least one user device associated with the at least one additional payment instrument.

4. The computer-implemented method of claim 1, comprising receiving, by the processor, the one or more parameters comprising one or more rules, wherein the one or more rules limit use of the payment instrument.

5. The computer-implemented method of claim 4, comprising:
receiving, by the processor, a rule limiting the payment instrument to a specific class of merchants; and
generating, by the processor, a targeted offer for the specific class of merchants.

6. The computer-implemented method of claim 4, comprising:
receiving, by the processor, a rule limiting the payment instrument to a specific merchant; and
generating, by the processor, a targeted offer for the specific merchant.

7. The computer-implemented method of claim 1, comprising:
receiving, by the processor, analytical data; and
generating, by the processor, the one or more targeted offers based on the analytical data.

8. The computer-implemented method of claim 7, comprising receiving, by the processor, analytical data representative of a purchase action associated with the payment instrument.

9. The computer-implemented method of claim 7, comprising receiving, by the processor, analytical data associated with the one or more targeted offers, wherein the analytical data associated with the one or more targeted offers indicates a success of the targeted offer.

10. The computer-implemented method of claim 7, comprising providing, by the processor, screened analytical data to a merchant.

11. A computer-implemented method for implementing an intent to spend analytics platform, the method comprising:
receiving, by a processor configured to execute a pre-commerce screening engine, analytical data associated with a user; and
generating, by the processor, one or more targeted offers based on the analytical data associated with the user.

12. The computer-implemented method of claim 11, comprising receiving, by the processor, analytical data comprising one or more parameters of a payment instrument associated with the user.

13. The computer-implemented method of claim 11, comprising receiving, by the processor, analytical data comprising transaction history associated with the user.

14. The computer implemented method of claim 11, comprising transmitting, by the processor, the one or more targeted offers to a user device associated with the user.

15. An apparatus for providing an intent to spend analytics platform, the apparatus comprising:
a processor; and
a memory unit operatively coupled to the processor, wherein the memory unit is configured to store a plurality of instructions, and wherein the plurality of instructions is configured to program the processor to execute a pre-commerce screening engine to:
receive one or more parameters of a payment instrument; and
generate one or more targeted offers based on the one or more parameters of the payment instrument.

16. The apparatus of claim 15, wherein the instructions further program the processor to transmit the one or more targeted offers to a user device.

17. The apparatus of claim 15, wherein the instructions further program the processor to:
identify at least one additional payment instrument comprising the one or more parameters of the payment instrument; and
transmit the one or more targeted offers to at least one user device associated with the at least one additional payment instrument.

18. The apparatus of claim 15, wherein the instructions further program the processor to:
receive analytical data; and
generate the one or more targeted offers based on the analytical data.

19. The apparatus of claim 18, wherein the analytical data is representative of a purchase action associated with the payment instrument.

20. The apparatus of claim 18, wherein the analytical data is associated with the one or more targeted offers, and wherein the analytical data associated with the one or more targeted offers indicates a success of the targeted offer.

21. The apparatus of claim 18, wherein the instructions further program the processor to provide screened analytical data to a merchant.
